(19) United States
(12) Patent Application Publication
(10) Pub. No.: US 2014/0269542 A1
(43) Pub. Date: Sep. 18, 2014

(54) MEDIA OFFLOAD FOR MOBILE COMMUNICATIONS APPLICATIONS

(71) Applicants: Jeffrey Brian Kay, Bellevue, WA (US); John David Bruner, Bellevue, WA (US); Sebastien Zimmermann, Seattle, WA (US)

(72) Inventors: Jeffrey Brian Kay, Bellevue, WA (US); John David Bruner, Bellevue, WA (US); Sebastien Zimmermann, Seattle, WA (US)

(21) Appl. No.: 13/914,647

(22) Filed: Jun. 11, 2013

Related U.S. Application Data
(60) Provisional application No. 61/800,379, filed on Mar. 15, 2013.

(51) Int. Cl. H04L 29/06

(52) U.S. Cl. CPC H04L 65/60
USPC 370/329

(57) ABSTRACT

Various technologies described herein pertain to operating a multi-processor mobile device. An application client executing on an application processor of the multi-processor mobile device negotiates a media session with a service. Responsive to the media session being negotiated, a media offload request is signaled from the application processor to a baseband processor of the multi-processor mobile device. The media offload request includes identification information that signifies packets that form part of the media session. Responsive to receipt of the media offload request, incoming packets received by the baseband processor from a base station are evaluated to detect whether the incoming packets form part of the media session. The incoming packets that form part of the media session are redirected from the baseband processor to a digital signal processor without being routed through the application processor and processed to generate an output, where the output is transmitted to an output device.

### CROSS-REFERENCE TO RELATED APPLICATION

This application claims priority to U.S. Provisional Patent Application No. 61/800,379, filed on Mar. 15, 2013, and entitled “MEDIA OFFLOAD FOR MOBILE COMMUNICATIONS APPLICATIONS”, the entirety of which is incorporated herein by reference.

### BACKGROUND

Mobile devices oftentimes include a baseband processor, a digital signal processor (e.g., an audio digital signal processor), and an application processor. In a common mobile architecture, a carrier-supported media session for a voice call (e.g., in a circuit switched network or a packet switched network) can be handled by the baseband processor and the digital signal processor, without the application processor. For instance, the baseband processor can receive an incoming audio stream from a node (e.g., a base station) of a network (e.g., cellular network) and route the incoming audio stream directly to an audio digital signal processor. The audio digital signal processor can decode the incoming audio stream and play the incoming audio stream on an output audio device, such as a speaker. Accordingly, output can be provided to the output device without the application processor handling the incoming audio stream.

An outgoing audio stream obtained by an audio input device (e.g., a microphone) of the mobile device can similarly be handled without employing the application processor in the carrier-supported media session. For instance, the audio digital signal processor can receive the outgoing audio stream from the audio input device. Further, the audio digital signal processor can encode the outgoing audio stream and send the outgoing audio stream to the baseband processor. Thereafter, the baseband processor can cause the outgoing audio stream to be transmitted over the network. Inhibiting utilization of the application processor to handle the incoming and outgoing audio streams can provide power savings for the mobile device as compared to a scenario in which the application processor is employed to (at least partially) handle such streams.

In conventional architectures, the baseband processor negotiates setup of the carrier-supported media session with a base station. Based upon such negotiation, the baseband processor can route the incoming audio streams to the audio digital signal processor and the outgoing audio stream from the audio digital signal processor without invoking the application processor. However, other application clients that execute on the application processor are typically unable to employ redirection of media streams.

### SUMMARY

Described herein are various technologies that pertain to operating a multi-processor mobile device. The multi-processor mobile device can include an application processor, a baseband processor, and a digital signal processor. An application client executing on the application processor of the multi-processor mobile device can negotiate a media session with a service. Responsive to the media session being negotiated by the application client executing on the application processor, a media offload request can be signaled from the application processor to the baseband processor of the multi-processor mobile device. The media offload request can include identification information that signifies packets that form part of the media session. Responsive to receipt of the media offload request, incoming packets received by the baseband processor from a base station can be evaluated (e.g., by the baseband processor) to detect whether the incoming packets form part of the media session (e.g., based upon the identification information). The incoming packets that form part of the media session can be redirected from the baseband processor to the digital signal processor of the multi-processor mobile device without being routed through the application processor. Further, redirected packets can be processed on the digital signal processor to generate an output, and the output can be transmitted to an output device.

According to various embodiments, input can be received by the digital signal processor of the multi-processor mobile device from an input device. The input can be processed on the digital signal processor to generate outgoing packets. The outgoing packets can be sent from the digital signal processor to the baseband processor. Further, upon receiving the media offload request, the baseband processor can detect whether the outgoing packets received by the baseband processor from the digital signal processor form part of the media session (e.g., based upon the identification information signaled as part of the media offload request). The outgoing packets that form part of the media session can be transmitted from the baseband processor to the base station without being routed through the application processor.

In accordance with various embodiments, the identification information that signifies packets that form part of the media session can be determined during the negotiation performed by the application client executing on the application processor. The identification information, for example, can include an Internet Protocol (IP) address and port number for an endpoint (e.g., to which packets are sent).

According to various embodiments, a Wi-Fi system included in the multi-processor mobile device can detect whether packets form part of the media session and redirect the packets that form part of the media session without routing such packets through the application processor. Thus, the application client executing on the application processor of the multi-processor mobile device can negotiate the media session with the service. In response to the media session being negotiated by the application client, the media offload request can be signaled from the application processor to the Wi-Fi system. Responsive to receipt of the media offload request, the Wi-Fi system can detect whether incoming packets received thereby form part of the media session. The incoming packets that form part of the media session can be redirected from the Wi-Fi system to the digital signal processor without being routed through the application processor. For example, the incoming packets that form part of the media session can be directly forwarded from the Wi-Fi system to the digital signal processor. According to another example, the incoming packets that form part of the media session can be routed from the Wi-Fi system to the baseband processor of the multi-processor mobile device, and the baseband processor can further send the incoming packets received from the Wi-Fi system to the digital signal processor. Redirected packets received by the digital signal processor can be processed on the digital signal processor to generate the output, and the output can be transmitted to the output device.

Moreover, in accordance with various embodiments, outgoing packets generated by the digital signal processor can be sent from the digital signal processor to the Wi-Fi system without being routed through the application processor. The outgoing packets, for example, can be directly sent from the digital signal processor to the Wi-Fi system. By way of a further example, the outgoing packets can be sent from the digital signal processor to the Wi-Fi system via the baseband processor. Upon receiving the media offload request, the Wi-Fi system can further detect whether the outgoing packets received from the digital signal processor form part of the media session based upon the identification information signaled as part of the media offload request. Moreover, the outgoing packets that form part of the media session can be transmitted from the Wi-Fi system to the base station without being routed through the application processor.

Various embodiments described herein pertain to an apparatus for wireless communication that includes a processor. The processor can be a baseband processor or a Wi-Fi system, for example. Moreover, the processor can be configured to receive a media offload request from an application processor. Further, the processor can be configured to, responsive to receipt of the media offload request, detect whether incoming packets received from a base station form part of a media session based upon identification information included in the media offload request. The processor can also be configured to redirect the incoming packets that form part of the media session to a digital signal processor without being routed through the application processor.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 illustrates a functional block diagram of an exemplary system that offloads media sessions from an application processor of a mobile device.

FIG. 2 illustrates a functional block diagram of an exemplary system that offloads a media session for a mobile communications application.

FIG. 3 illustrates a functional block diagram of an exemplary system that implements redirecting packets responsive to the media offload request as set forth herein.

FIG. 4 illustrates a functional block diagram of an exemplary system that implements redirection of packets based on the media offload request.

FIG. 5 illustrates a functional block diagram of an exemplary system that streams audio and/or video to a mobile device.

FIG. 6 illustrates a functional block diagram of an exemplary system that offloads a media session for an application, where a mobile device and a base station (e.g., an access point) communicate via Wi-Fi.

FIG. 7 is a flow diagram that illustrates an exemplary methodology of operating a multi-processor mobile device.

FIG. 8 is a flow diagram that illustrates an exemplary methodology of operating a multi-processor mobile device.

FIG. 9 is a flow diagram that illustrates an exemplary methodology of redirecting packets with a processor.

FIG. 10 illustrates an exemplary computing device.

### DETAILED DESCRIPTION

Various technologies pertaining to offloading processing of a media session for an application in a multi-processor mobile device from an application processor are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

As set forth herein, an application client executing on an application processor of a multi-processor mobile device can negotiate a media session with a service. Negotiation can result in the application client receiving identification information for the media session. The identification information, for example, can include an Internet Protocol (IP) address and port number of an endpoint (or IP addresses and port numbers for endpoints). Conventional handling of such a media session includes collecting media packets for the IP address and port number, and processing such media packets in the application processor. In contrast, as provided herein, after the media session is negotiated by the application client executing on the application processor, the application client can inform a baseband processor (e.g., via a media offload request) to detect packets addressed to the particular IP address and port number and route the detected packets to a digital signal processor of the multi-processor mobile device (without sending the detected packets through the application processor). Responsive to receipt of the media offload request, incoming packets received by the baseband processor can be inspected, where the incoming packets that have the specified combination of IP address and port number can be rerouted (e.g., to the digital signal processor as opposed to the application processor). Similarly, outgoing packets received by the baseband processor from the digital signal processor can be inspected; the outgoing packets that have the specified combination of IP address and port number can be transmitted by the baseband processor (e.g., to a base station) rather than being provided to the application processor.

Referring now to the drawings, FIG. 1 illustrates a system 100 that offloads media sessions from an application processor of a mobile device 102. The mobile device 102 can transmit packets, information, signals, data, instructions, commands, bits, symbols, and the like over a channel (e.g., uplink) to a base station 104, and receive packets, information, signals, data, instructions, commands, bits, symbols, and the like over a channel (e.g., downlink) from the base station 104. The base station 104 can also be referred to as an access point, a node B, a home node B, an evolved node B, or the like.

The mobile device 102 can be a mobile phone, a tablet computer, or the like. Moreover, the mobile device 102 is a multi-processor mobile device. More particularly, the mobile device 102 includes a baseband processor 106 (e.g., a modem), a digital signal processor 108, and an application processor 110. The baseband processor 106 can manage radio functions of the mobile device 102. Thus, the baseband processor 106 can cause packets to be transmitted from the mobile device 102 to the base station 104. Moreover, the baseband processor 106 can receive packets from the base station 104 at the mobile device 102.

The digital signal processor 108 can be a specialized processor with architecture designed for a given operational task. The digital signal processor 108 can have a limited instruction set as compared to the application processor 110. Moreover, the digital signal processor 108 can include a codec 116. Further, although not shown, it is contemplated that the digital signal processor 108 can include additional post processing components (e.g., decryption component, etc.). According to an example, the digital signal processor 108 can be an audio digital signal processor, which can include an audio codec. According to another example, the digital signal processor 108 can be a video encoding/decoding processor (e.g., an H.264 video encoding/decoding processor, etc.); however, the claimed subject matter is not so limited.

The application processor 110 can include an application client 112. The application client 112 can execute on the application processor 110. More particularly, the application client 112 can negotiate a media session with a service 114. The service 114 can exchange data over an infrastructure (e.g., a network 128, the base station 104, etc.). According to an example, the service 114 can be provided by a carrier. Following this example, the infrastructure (or at least a portion thereof) over which the service 114 exchanges data is under administrative control of a provider of the service 114. By way of another example, the service 114 can be an over-the-top (OTT) service. Pursuant to this example, the infrastructure over which the service 114 exchanges data is not under administrative control of a provider of the service 114.

The application client 112 can negotiate with the service 114 to set information used for detecting packets that form part of a media session. For instance, the information can include an IP address and a port number of an endpoint (or IP addresses and port numbers for endpoints) for the media session. The application client 112 can set up a pipeline (e.g., pre-processing, decryption, codec(s), etc.) for the media session in advance of rerouting.

The application client 112 can utilize a wireless wide area network (WWAN) interface 118 of the application processor 110 to communicate with the baseband processor 106, and hence, the service 114 (e.g., since packets exchanged between the application client 112 and the service 114 are routed by the baseband processor 106). Accordingly, packets can be received by the application client 112 via the WWAN interface 118 from the baseband processor 106 and/or transmitted from the application client 112 via the WWAN interface 118 to the baseband processor 106.

The baseband processor 106 can further include a redirection component 120 that can route packets received from the base station 104 to the application processor 110 or the digital signal processor 108. The redirection component 120 can send packets to the application processor 110 via the WWAN interface 118 of the application processor 110 and/or receive packets from the WWAN interface 118 of the application processor 110. Moreover, the redirection component 120 can send packets to the digital signal processor 108 and/or receive packets from the digital signal processor 108.

The application processor 110 further includes a wireless connection component 122 that provides a basic set of wireless connect-oriented services (e.g., state management, etc.). The wireless connection component 122, for example, can include an application programming interface (API) that can be utilized to communicate with the baseband processor 106. Responsive to the media session being negotiated by the application client 112, the application client 112 can send a media offload request to the wireless connection component 122; the wireless connection component 122 can signal the media offload request to the baseband processor 106. The media offload request can include identification information that specifies packets that form part of the media session (e.g., the identification information can include the IP address and port number). Thus, the application client 112 can pass the media offload request to the baseband processor 106 (e.g., to the redirection component 120) with the identification information that describes the media session.

Responsive to receipt of the media offload request, the redirection component 120 can evaluate packets received from the base station 104 and/or packets received from the digital signal processor 108 to determine whether the packets form part of the media session. For example, the redirection component 120 can detect incoming packets received by the baseband processor 106 from the base station 104 that form part of the media session. The incoming packets, for instance, can be unpacked by the baseband processor 106. The incoming packets that are detected to form part of the media session by the redirection component 120 can be redirected to the digital signal processor 108 without being sent through the application processor 110. Additionally, the incoming packets that are detected to not be part of the media session are routed by the redirection component 120 from the baseband processor 106 to the application processor 110. The redirection component 120 can redirect packets of the media session without the baseband processor 106 participating in the negotiation to initialize the media session (e.g., other than having packets exchanged between the application client 112 and the service 114 pass there through).

Moreover, the digital signal processor 108 can process the redirected packets received from the baseband processor 106 to generate an output. The output can thereafter be transmitted to an output device 124 (e.g., a speaker, a display, etc.). Accordingly, responsive to the media offload request, the redirection component 120 can cause the incoming packets detected as part of the media session to be sent directly to the digital signal processor 108 as opposed to being sent to the application processor 110.

Moreover, input can be received from an input device 126 (e.g., a microphone, a camera, etc.). The input can be processed on the digital signal processor 108 to generate outgoing packets. Further, the outgoing packets can be sent from the digital signal processor 108 to the baseband processor 106 (e.g., the redirection component 120). The redirection component 120 can detect whether the outgoing packets received by the baseband processor 106 from the digital signal processor 108 form part of the media session based upon the identification information from the media offload request. The baseband processor 106 can package the outgoing packets that are detected to form part of the media session, for example. Moreover, the baseband processor 106 can transmit the outgoing packets (e.g., packaged packets) that form part of in the media session to the base station 104 without sending such outgoing packets through the application processor 110 (e.g., from the base station 104 the outgoing packets can thereafter be sent over the network 128 to the endpoint).

The mobile device 102 can include the output device 124 and the input device 126 as depicted in FIG. 1. However, according to other examples, it is contemplated that the output device 124 and/or the input device 126 can be separate from the mobile device 102.

Further, the baseband processor 106 can signal to the application processor 110 (e.g., the application client 112) while the media session is ongoing. For instance, the baseband processor 106 can provide notification of the media session continuing to the application processor 110.

While the redirection component 120 is described as being executed by the baseband processor 106, it is further contemplated that that redirection component 120 can be executed by a disparate processor of the mobile device 102 other than the processor (e.g., the application processor 110) that executes the application client 112.

Further, while the baseband processor 106, the digital signal processor 108, and the application processor 110 are described as being disparate processors, it is contemplated that two or more of such processors can be disparate cores of a multicore processor.

Now turning to FIG. 2, illustrated is a system 200 that offloads a media session for a mobile communications application. Again, the mobile device 102 is a multi-processor mobile device. More particularly, the mobile device 102 of FIG. 2 includes the baseband processor 106, an audio digital signal processor 208, and an application processor 110. Thus, the digital signal processor (e.g., the digital signal processor 108 of FIG. 1) included in the mobile device 102 in the example of FIG. 2 is the audio digital signal processor 208. As shown in FIG. 2, an application client (e.g., the application client 112 of FIG. 1) executing on the application processor 110 is a Voice over IP (VoIP) client 202 and a service (e.g., the service 114 of FIG. 1) is a VoIP service 204.

The application processor 110 can also include a phone service 206. The phone service 206 can initiate a carrier-supported media session for a voice call (e.g., carrier-supported voice connection). The phone service 206 can communicate through the wireless connection component 122 with the baseband processor 106 to cause the baseband processor 106 to negotiate the carrier-supported media session (e.g., the baseband processor 106 can negotiate the carrier-supported media session with the base station 104 or disparate component(s) included in the network 128). Thus, the wireless connection component 122 can communicate with the baseband processor 106, which can cause the baseband processor 106 to initiate a call. Accordingly, for carrier-supported voice communications, the baseband processor 106 can negotiate the media session, thereby enabling the redirection component 120 to route packets associated with such media session.

In contrast to employing the phone service 206, which causes the baseband processor 106 to negotiate the media session, the VoIP client 202 executing on the application processor 110 can negotiate a media session with the VoIP service 204. According to an example, the media session can be negotiated by the VoIP client 202 responsive to receipt of an incoming call to the mobile device 102 or initiation of an outgoing call from the mobile device 102.

After signaling a call and negotiating endpoints for the call, the VoIP client 202 can send a media offload request to the baseband processor 106 identifying the endpoints (e.g., the media offload request can include the identification information which can specify IP address(es) and port number(s) of endpoint(s)). The following describes operation of the mobile device 102 with respect to incoming audio packets and outgoing audio packets responsive to the VoIP client 202 signaling the media offload request to the baseband processor 106.

Incoming audio packets can be received by the baseband processor 106 of the mobile device 102. The incoming audio packets can arrive over a cellular data connection from the base station 104. As described in greater detail below (in FIGS. 3-4), the incoming audio packets can be unpacked and the redirection component 120 can be invoked to determine whether to send the unpacked audio packets to the application processor 110 via the WWAN interface 118 or the audio digital signal processor 208. To satisfy the media offload request, the packets detected to form part of the media session can be pushed to the audio digital signal processor 208, where such packets can be processed. For instance, the audio packets can be sent through the codec 116 as well as other post processing components (e.g., to handle headers that correspond to the VoIP client 202 and the VoIP service 204). The raw audio stream can then be sent to the output device 124 (e.g., a speaker).

Moreover, audio output packets from the input device 126 can be sent to the audio digital signal processor 208 for encoding and packetization. These packets can then be sent from the audio digital signal processor 208 to the redirection component 120 of the baseband processor 106 to determine whether to send the packets over the wireless connection to the base station 104. To satisfy the media offload request, the redirection component 120 can inject the packets into the media stream and send such packets out to the VoIP service 204 via the base station 104.

While the application client is described as being the VoIP client 202 and the service is described as being the VoIP service 204 in the example set forth in FIG. 2, it is contemplated that in accordance with other examples the application client can be a streaming audio client (e.g., streaming music client) and the service can be a streaming audio service (e.g., streaming music service), the application client can be a streaming video client and the service can be a streaming video service, a combination thereof, and so forth.

With reference to FIG. 3, illustrated is a system 300 that implements redirecting packets responsive to the media offload request as set forth herein. The system 300 includes the mobile device 102, which can further include the baseband processor 106, the digital signal processor 108, and the application processor 110. In the example set forth in FIG. 3, the baseband processor 106 includes an IP layer 302, a User Datagram Protocol (UDP) layer 304, and a Real-time Transport Protocol (RTP) layer 306.

Upon receipt of incoming packets from the base station 104 at the baseband processor 106, the incoming packets can be unpacked via the IP layer 302, the UDP layer 304, and the RTP layer 306 at the baseband processor 106 to generate raw packets. If the redirection component 120 determines that the incoming packets are part of the media session specified by the media offload request, then the raw packets can be redirected to the digital signal processor 108 (without being routed through the application processor 110) for further processing. Alternatively, if the redirection component 120 determines that the incoming packets are not part of a media session specified by a media offload request, then the raw packets can be sent to the application processor 110 via the WWAN interface 118.

Further, raw packets (e.g., output by the codec 116) can be sent from the digital signal processor 108 to the baseband processor 106. If the redirection component 120 determines that the raw packets received from the digital signal processor 108 are part of the media session, then the raw packets can be compressed and packaged via the RTP layer 306, the UDP layer 304, and the IP layer 302 into packaged packets for transport to the base station 104 (without being routed through the application processor 110). Alternatively, the raw packets can be sent to the application processor 110 via the WWAN interface 118 if the redirection component 120 determines that the raw packets are not part of the media session.

Referring now to FIG. 4, illustrated is another system 400 that implements redirection of packets based on the media offload request. The system 400 includes the mobile device 102, which can again include the baseband processor 106, the digital signal processor 108, and the application processor 110. In the example set forth in FIG. 4, the baseband processor 106 includes the IP layer 302 and the UDP layer 304. Moreover, the digital signal processor 108 includes the RTP layer 306 in the example depicted in FIG. 4.

In the system 400, packets can be redirected by the redirection component 120 at the level of UDP. Incoming packets received by the baseband processor 106 from the base station 104 can be unpacked via the IP layer 302 and the UDP layer 304 at the baseband processor 106 to generate UDP packets. Accordingly, UDP packets detected to form part of the media session can be routed by the redirection component 120 from the baseband processor 106 to the digital signal processor 108 (without being routed through the application processor 110). Further, the RTP layer 306 of the digital signal processor 108 can further unpack the UDP packets received from the baseband processor 106 to obtain raw packets, which can then be input to the codec 116 of the digital signal processor 108 (and further processed by other components of the digital signal processor 108 (not shown)).

Moreover, input data received from the input device 126 can be encoded by the codec 116. Further, raw packets output by the codec 116 can be packaged via the RTP layer 306 of the digital signal processor 108 into UDP packets, which can be sent from the digital signal processor 108 to the baseband processor 106. The UDP packets can be injected into a UDP stream by the redirection components 120 and sent over the air to the base station 104.

Although not shown, it is also contemplated that digital signal processor 108 can include an application specific layer in addition to or instead of the RTP layer 306. Accordingly, the application specific layer can enable packing and unpacking packets based upon a protocol of a particular application (e.g., associated with the application client 112 and the service 114). By way of example, the application specific layer can employ the protocol of the particular application to package outgoing UDP packets sent from the digital signal processor 108 to the baseband processor 106. Further, the application specific layer can employ the protocol of the particular application to unpack incoming UDP packets received at the digital signal processor 108 from the baseband processor 106 (and the unpacked data can thereafter be further processed by the digital signal processor 108). Pursuant to an illustration, it is contemplated that the protocol of the particular application utilized by the application specific layer can be randomly modified; yet, the claimed subject matter is not so limited.

According to another example, the baseband processor 106 can remove turn headers from incoming packets and insert turn headers into outgoing packets. Following this example, header information can be inserted into outgoing packets at the baseband processor 106.

It is contemplated that the examples set forth in FIGS. 3-4 can be extended to a scenario where the mobile device 102 includes a Wi-Fi system (in addition to or instead of the baseband processor 106). For instance, as illustrated below in FIG. 6, the mobile device 102 can include the application processor 110, the digital signal processor 108, and a Wi-Fi system (e.g., a Wi-Fi system 602). According to an illustration, similar to the example set forth in FIG. 3, the Wi-Fi system can include the IP layer 302, the UDP layer 304, and the RTP layer 306. By way of another illustration, similar to the example set forth in FIG. 4, the Wi-Fi system can include the IP layer 302 and the UDP layer 304, and the digital signal processor 108 can include the RTP layer 306 and/or an application specific layer. Further, it is contemplated that the examples described in FIGS. 3-4 can be extended to a scenario where the digital signal processor 108 is an audio digital signal processor, a video decoding processor, or so forth.

Turning to FIG. 5, illustrated is a system 500 that streams audio and/or video to the mobile device 102. Accordingly, the application client (e.g., the application client 112 of FIG. 1) executing on application processor 110 of the mobile device 102 can be a streaming client 502 (e.g., a streaming video client and/or a streaming audio client). Moreover, a service (e.g., the service 114 of FIG. 1) can be a streaming service 504 (e.g., a streaming video service and/or a streaming audio service).

The streaming client 502 (e.g., executing on the application processor 110) and the streaming service 504 can negotiate an audio session and a video session. Responsive to the audio session and the video session being negotiated, the streaming client 502 can signal the media offload request from the application processor 110 to the baseband processor 106 via the wireless connection component 122. According to this example, the media offload request can include identification information for the audio session and the video session. It is contemplated that separate media offload requests for the audio session and the video session can be sent from the streaming client 502 to the baseband processor 106 via the wireless connection component 122, for example. By way of another example, it is to be appreciated that a combined media offload request for both the audio session and the video session can be sent from the streaming client 502 to the baseband processor 106 via the wireless connection component 122.

The redirection component 120 can detect audio packets and video packets based upon the identification information from the media offload request(s). Moreover, the redirection component 120 can send the audio packets to an audio digital signal processor 506 and video packets to a video decoding processor 508 (e.g., an H.264 decoding processor, etc.) without the audio packets or the video packets being routed through the application processor 110. The audio packets can be processed by the audio digital signal processor 506 to generate an output that can be transmitted to an audio output device 510 (e.g. a speaker). Moreover, the video decoding processor 508 can decode the video packets and provide output to the streaming client 502 via a video interface 512 of the application processor 110. Accordingly, the streaming client 502 can render video on a video output device 514 (e.g., a display) of the mobile device 102 based upon the output received from the video decoding processor 508. According to another example (not shown), it is contemplated that the video decoding processor 508 can directly provide the output to the video output device 514; yet, the claimed subject matter is not so limited.

Turning to FIG. 6, illustrated is a system 600 that offloads a media session for an application. In the example of FIG. 6, the mobile device 102 and the base station 104 (e.g., an access point) communicate via Wi-Fi. The mobile device 102 included in the system 600 can include the digital signal processor 108, the application processor 110, and a Wi-Fi system 602.

The Wi-Fi system 602 can operate in a substantially similar manner as compared to the baseband processor 106 described herein. Further, the Wi-Fi system 602 can include the redirection component 120 as described herein. Moreover, the application client 112 can communicate with the Wi-Fi system 602 via a Wi-Fi interface 604. Accordingly, it is to be appreciated that the Wi-Fi system 602 can be substituted for the baseband processor 106 in various embodiments described herein.

For instance, the application client 112 can execute on the application processor 110. The application client 112 can negotiate a media session with the service 114 to set information used for detecting packets that form part of the media session. In the example of FIG. 6, the application client 112 can utilize the Wi-Fi interface 604 of the application processor 110 to communicate with the Wi-Fi system 602 to negotiate the media session with the service 114 (e.g., packets exchanged between the application client 112 and the service 114 can be routed by the Wi-Fi system 602).

Responsive to negotiating the media session with the service 114, the application client 112 executing on the application processor 110 can signal a media offload request from the application processor 110 to the Wi-Fi system 602 (e.g., via the wireless connection component 122). The media offload request can include the identification information that signifies packets that form part of the media session. Responsive to receipt of the media offload request, the redirection component 120 of the Wi-Fi system 602 can detect whether incoming packets received by the Wi-Fi system 602 from the base station 104 form part of the media session. The incoming packets that are detected to form part of the media session can be redirected by the redirection component 120 from the Wi-Fi system 602 to the digital signal processor 108 without being routed through the application processor 110. In the example depicted in FIG. 6, the incoming packets that are detected to form part of the media session can be directly forwarded from the Wi-Fi system 602 to the digital signal processor 108. Redirected packets received by the digital signal processor 108 can thereafter be processed to generate an output, and the output can be transmitted to the output device 124.

Further, input received by the input device 126 can be processed on the digital signal processor 108 to generate outgoing packets, which can be sent from the digital signal processor 108 to the Wi-Fi system 602 (e.g., the redirection component 120). As illustrated, the outgoing packets can be directly forwarded from the digital signal processor 108 to the Wi-Fi system 602. The redirection component 120 can detect whether the outgoing packets received by the Wi-Fi system 602 from the digital signal processor 108 form part of the media session based upon the identification information from the media offload request. Moreover, the Wi-Fi system 602 can transmit the outgoing packets (e.g., packaged packets) that are detected to form part of the media session to the base station 104 (without being sent through the application processor 110).

According to various embodiments, it is contemplated that the mobile device 102 can include both the Wi-Fi system 602 and the baseband processor 106. By way of illustration, the Wi-Fi system 602 can receive the incoming packets from the base station 104. Thus, the redirection component 120 of the Wi-Fi system 602 can detect whether the incoming packets received by the Wi-Fi system 602 from the base station 104 form part of the media session. As described above, the incoming packets that are detected to form part of the media session can be directly forwarded from the Wi-Fi system 602 to the digital signal processor 108. According to another example, the incoming packets that are detected to form part of the media session can be redirected to the digital signal processor 108 via the baseband processor 106 without being routed through the application processor 110. Following this example, the incoming packets that are detected to form part of the media session can be routed from the Wi-Fi system 602 to the baseband processor 106 (without being routed through the application processor 110); further, the incoming packets that are detected to form part of the media session received from the Wi-Fi system 602 can be sent from the baseband processor 106 to the digital signal processor 108 (without being routed through the application processor 110). Similarly, it is contemplated that outgoing packets generated by the digital signal processor 108 can be directly sent to the Wi-Fi system 602 or sent to the Wi-Fi system 602 via the baseband processor 106 (without being routed through the application processor 110).

Again, pursuant to various embodiments, it is to be appreciated that the mobile device 102 can include both the Wi-Fi system 602 and the baseband processor 106. The application client 112 can negotiate the media session with the service 114 to set information used for detecting packets that form part of the media session utilizing the Wi-Fi system 602 and/or the baseband processor 106 (e.g., packets exchanged between the application client 112 and the service 114 for negotiating the media session can be sent through the Wi-Fi system 602 and/or the baseband processor 106). Responsive to negotiating the media session with the service 114, the application client 112 executing on the application processor 110 can signal the media offload request from the application processor 110 to the Wi-Fi system 602 and/or the baseband processor 106. The Wi-Fi system 602 and the baseband processor 106 can redirect packets as described herein responsive to receipt of the media offload request. According to an example, the baseband processor 106 can redirect packets that form part of the media session which are sent and/or received via a cellular channel. Following this example, the packets that form part of the media session can be switched to being sent and/or received via a Wi-Fi channel; thus, upon switching to the Wi-Fi channel, the Wi-Fi system 602 can redirect packets that form part of the media session which are sent and/or received via the Wi-Fi channel. By way of another example, it is contemplated that the packets that form part of the media session can be switched from being sent and/or received via the Wi-Fi channel to being sent and/or received via the cellular channel.

FIGS. 7-9 illustrate exemplary methodologies relating to media offload for mobile communications applications. While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

FIG. 7 illustrates a methodology 700 of operating a multi-processor mobile device. At 702, a media session can be negotiated with a service. The media session can be negotiated by an application client executing on an application processor of the multi-processor mobile device. At 704, a media offload request can be signaled from the application processor to a baseband processor of the multi-processor mobile device. The media offload request can be signaled responsive to the media session being negotiated by the application client. Moreover, the media offload request can include identification information that signifies packets that form part of the media session. At 706, responsive to receipt of the media offload request, incoming packets received by the baseband processor from a base station can be evaluated to detect whether the incoming packets form part of the media session. For instance, the incoming packets can be unpacked at the baseband processor (e.g., to generate UDP packets, raw packets, etc.). At 708, the incoming packets that form part of the media session can be redirected from the baseband processor to a digital signal processor of the multi-processor mobile device without being routed through the application processor. Alternatively, incoming packets that are not part of the media session can be routed from the baseband processor to the application processor. At 710, redirected packets can be processed on the digital signal processor to generate an output. At 712, the output can be transmitted to an output device.

Turning to FIG. 8, illustrated is a methodology 800 of operating a multi-processor mobile device. At 802, input can be received from an input device at a digital signal processor of the multi-processor mobile device. At 804, the input can be processed on the digital signal processor to generate outgoing packets. At 806, the outgoing packets can be sent from the digital signal processor to the baseband processor. At 808, whether the outgoing packets received by the baseband processor from the digital signal processor form part of a media session can be detected based upon identification information from a media offload request. The media offload request can be signaled responsive to the media session being negotiated by an application client executing on an application processor of the multi-processor mobile device. For instance, the outgoing packets that form part of the media session can be packaged utilizing the baseband processor. At 810, the outgoing packets that form part of the media session can be transmitted from the baseband processor to a base station without being routed through the application processor.

With reference to FIG. 9, illustrated is a methodology 900 of redirecting packets with a processor (e.g., a baseband processor, a Wi-Fi system). At 902, a media offload request can be received from an application processor. The media offload request can include identification information that signifies packets that form part of a media session. At 904, responsive to receipt of the media offload request, incoming packets received from a base station can be evaluated to detect whether such incoming packets form part of the media session based upon the identification information. At 906, the incoming packets that form part of the media session can be redirected to a digital signal processor without being routed through the application processor. Alternatively, the incoming packets that are not part of the media session can be sent to the application processor. Moreover, it is contemplated that the processor can receive outgoing packets from the digital signal processor, detect whether the outgoing packets form part of a media session based upon the identification information from the media offload request, and transmit the outgoing packets that form part of the media session to the base station without being routed through the application processor.

Referring now to FIG. 10, a high-level illustration of an exemplary computing device 1000 that can be used in accordance with the systems and methodologies disclosed herein is illustrated. For instance, the computing device 1000 may be used in a system that negotiates a media session with a service with an application client executing on an application processor, and offloads processing of the media session from the application processor to other processor(s) (e.g., a digital signal processor). The computing device 1000 includes at least one processor 1002 that executes instructions that are stored in a memory 1004. The instructions may be, for instance, instructions for implementing functionality described as being carried out by one or more components discussed above or instructions for implementing one or more of the methods described above. The processor 1002 may access the memory 1004 by way of a system bus 1006. In addition to storing executable instructions, the memory 1004 may also store identification information and so forth.

The computing device 1000 additionally includes a data store 1008 that is accessible by the processor 1002 by way of the system bus 1006. The data store 1008 may include executable instructions, identification information, etc. The computing device 1000 also includes an input interface 1010 that allows external devices to communicate with the computing device 1000. For instance, the input interface 1010 may be used to receive instructions from an external computer device, from a user, etc. The computing device 1000 also includes an output interface 1012 that interfaces the computing device 1000 with one or more external devices. For example, the computing device 1000 may display text, images, etc. by way of the output interface 1012.

It is contemplated that the external devices that communicate with the computing device 1000 via the input interface 1010 and the output interface 1012 can be included in an environment that provides substantially any type of user interface with which a user can interact. Examples of user interface types include graphical user interfaces, natural user interfaces, and so forth. For instance, a graphical user interface may accept input from a user employing input device(s) such as a keyboard, mouse, remote control, or the like and provide output on an output device such as a display. Further, a natural user interface may enable a user to interact with the computing device 1000 in a manner free from constraints imposed by input device such as keyboards, mice, remote controls, and the like. Rather, a natural user interface can rely on speech recognition, touch and stylus recognition, gesture recognition both on screen and adjacent to the screen, air gestures, head and eye tracking, voice and speech, vision, touch, gestures, machine intelligence, and so forth.

Additionally, while illustrated as a single system, it is to be understood that the computing device 1000 may be a distributed system. Thus, for instance, several devices may be in communication by way of a network connection and may collectively perform tasks described as being performed by the computing device 1000.

As used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices.

Further, as used herein, the term “exemplary” is intended to mean “serving as an illustration or example of something.”

Various functions described herein can be implemented in hardware, software, or any combination thereof. If implemented in software, the functions can be stored on or transmitted over as one or more instructions or code on a computer-readable medium. Computer-readable media includes computer-readable storage media. A computer-readable storage media can be any available storage media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and blu-ray disc (BD), where disks usually reproduce data magnetically and discs usually reproduce data optically with lasers. Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the details description or the claims, such term is intended to be inclusive in a manner similar to the term “comprising” as “comprising” is interpreted when employed as a transitional word in a claim.

1. A method of operating a multi-processor mobile device, comprising:
negotiating a media session with a service, wherein an application client executing on an application processor of the multi-processor mobile device negotiates the media session with the service;
responsive to the media session being negotiated by the application client, signaling a media offload request from the application processor to a baseband processor of the multi-processor mobile device, wherein the media offload request comprises identification information that signifies packets that form part of the media session;
responsive to receipt of the media offload request, detecting whether incoming packets received by the baseband processor from a base station form part of the media session based upon the identification information;
redirecting the incoming packets that form part of the media session from the baseband processor to a digital signal processor of the multi-processor mobile device without being routed through the application processor;
processing redirected packets on the digital signal processor to generate an output; and
transmitting the output to an output device.

2. The method of claim 1, further comprising:
receiving input from an input device at the digital signal processor;
processing the input on the digital signal processor to generate outgoing packets;
sending the outgoing packets from the digital signal processor to the baseband processor;
detecting whether the outgoing packets received by the baseband processor from the digital signal processor form part of the media session based upon the identification information; and
transmitting the outgoing packets that form part of the media session from the baseband processor to the base station without being routed through the application processor.

3. The method of claim 1, wherein the identification information that signifies packets that form part of the media session includes an Internet Protocol (IP) address and a port number.

4. The method of claim 1, wherein the service is an over-the-top (OTT) service.

5. The method of claim 1, wherein the media session is negotiated responsive to one of receipt of an incoming call to the multi-processor mobile device or initiation of an outgoing call from the multi-processor mobile device.

6. The method of claim 1, wherein the application client is a streaming audio client and the service is a streaming audio service.

7. The method of claim 1, wherein the application client is a streaming video client and the service is a streaming video service.

8. The method of claim 1, further comprising unpacking the incoming packets received by the baseband processor from the base station via an Internet Protocol (IP) layer and a User Datagram Protocol (UDP) layer at the baseband processor to generate UDP packets, wherein the UDP packets that for part of the media session are redirected from the baseband processor to the digital signal processor.

9. The method of claim 8, further comprising unpacking the UDP packets received by the digital signal processor from the baseband processor via a Real-time Transport Protocol (RTP) layer at the digital signal processor.

10. The method of claim 8, further comprising unpacking the UDP packets received by the digital signal processor from the baseband processor via an application specific layer at the digital signal processor, wherein the application specific layer is associated with a protocol of the application client and the service.

11. The method of claim 1, further comprising unpacking the incoming packets received by the baseband processor from the base station via an Internet Protocol (IP) layer, a User Datagram Protocol (UDP) layer, and a Real-time Transport Protocol (RTP) layer at the baseband processor to generate raw packets, wherein the raw packets that form part of the media session are redirected from the baseband processor to the digital signal processor.

12. The method of claim 1, further comprising routing the incoming packets that are not part of the media session from the baseband processor to the application processor.

13. A multi-processor mobile device, comprising:
a baseband processor;
an application processor that executes an application client, wherein the application client negotiates a media session with a service, wherein the application client signals a media offload request to the baseband processor responsive to the media session being negotiated, and wherein the media offload request comprises identification information that signifies packets that form part of the media session; and
a digital signal processor that receives input from an input device, processes the input to generate outgoing packets, and sends the outgoing packets to the baseband processor;
wherein the baseband processor detects whether the outgoing packets received from the digital signal processor form part of the media session based upon the identification information and transmits the outgoing packets that form part of the media session to a base station without being routed through the application processor.

14. The multi-processor mobile device of claim 13, wherein:
the baseband processor receives incoming packets from the base station, detects whether the incoming packets form part of the media session based upon the identification information, and redirects the incoming packets that form part of the media session to the digital signal processor without being routed through the application processor; and
the digital signal processor processes redirected packets received from the baseband processor to generate an output, and transmits the output to an output device.

15. The multi-processor mobile device of claim 13, wherein the digital signal processor is an audio digital signal processor.

16. An apparatus for wireless communication, comprising:
a processor configured to:
receive a media offload request from an application processor, wherein the media offload request comprises identification information that signifies packets that form part of a media session;
responsive to receipt of the media offload request, detect whether incoming packets received from a base station form part of the media session based upon the identification information; and
redirect the incoming packets that form part of the media session to a digital signal processor without being routed through the application processor.

17. The apparatus of claim 16, wherein the processor is a baseband processor.

18. The apparatus of claim 16, wherein the processor is a Wi-Fi system.

19. The apparatus of claim 16, wherein redirecting the incoming packets that form part of the media session to the digital signal processor without being routed through the application processor further comprises directly forwarding the incoming packets that form part of the media session to the digital signal processor.

20. The apparatus of claim 16, wherein redirecting the incoming packets that form part of the media session to the digital signal processor without being routed through the application processor further comprises routing the incoming packets that form part of the media session to a baseband processor, wherein the baseband processor sends the incoming packets that form part of the media session to the digital signal processor.
